(19) United States
(12) Patent Application Publication
(10) Pub. No.: US 2005/0053716 A1
(43) Pub. Date: Mar. 10, 2005

(54) Method of coating a light emanating component for an automobile lighting device

(76) Inventor: Hong-Jung Hsu, Tainan City (TW)

Correspondence Address: VEDDER PRICE KAUFMAN & KAMMHOLZ, 222 N. LASALLE STREET, CHICAGO, IL, 60601, US

(21) Appl. No.: 10/655,119

(22) Filed: Sep. 4, 2003

(51) Int. Cl. B05D 5/06

(52) U.S. Cl. 427/8; 427/111

(57) ABSTRACT

A method of coating a light emanating component includes the steps of providing a plurality of light emanating component samples having first and second zones, providing the samples with respective coatings by using different coating processes, measuring luminous intensity values of the samples produced at the first and second zones before and/or after the samples are coated, preparing first and second reference plots for the first and second zones of the samples, respectively, detecting third and fourth luminous intensity values produced at first and second zones of a bare light emanating component, respectively, preparing first and second assumption plots for the bare light emanating component, and coating the bare light emanating component using one of the coating processes that renders the first and second assumption plots to fall simultaneously within the standard range of luminous intensity values.

### BACKGROUND OF THE INVENTION

1. Field of the Invention

The invention relates to a method of coating a light emanating component for an automobile lighting device, more particularly to a method of coating a light emanating component for an automobile lighting device in which the light emanating component has at least first and second zones which produce standard luminous intensity values.

2. Description of the Related Art

An automobile lighting device, such as a taillight, generally includes a base shell provided with at least one inner lens. A transparent outer lens is disposed in front of the base shell. The inner lens is positioned in front of a bulb so as to transmit the light emanating from the bulb therethrough. The inner lens is usually red, yellow or white. The inner lens of the automobile lighting device should be tested for color temperature and luminous intensity at a plurality of measuring positions so as to determine whether or not it meets government regulated standards. For example, according to the ECE standard, the standard values are 42-185 cd at the first measuring position 5U-V, 54-185 cd at the second measuring position H-5R, 60-185 cd at the third measuring position H-V, 54-185 cd at the fourth measuring position H-5L, and 42-185 cd at the fifth measuring position 5D-V.

The inner and/or outer lens of the automobile lighting device is usually processed by forming a coating, such as by plating, so that the color appearance thereof can change according to ambient light when the automobile lighting device is turned off. However, there are various plating processes commonly used in the art, and not all of the plating processes can be used for a specific inner and/or outer lens. For example, the plating processing such as aluminum vapor deposition or mercury coating may severely affect the color temperature and/or the luminous intensity of the automobile lighting device when the latter is turned on such that the standard values are not met.

Furthermore, there are various automobile lighting devices that differ in shape and size. In order to meet the government regulated standards, especially the luminous intensity, an automobile lighting device having a relatively high luminous intensity is manufactured first. A surface finishing process such as polishing is then conducted. The automobile lighting device after the surface finishing process is subsequently tested to determine whether it meets the government regulated standards. If the automobile lighting device does not meet the government regulated standards, the surface finishing process should be repeated at least one more time until the standards are met. Therefore, the conventional method for manufacturing an automobile lighting device that meets the government regulated standards is complicated and time-consuming.

### SUMMARY OF THE INVENTION

The main object of the present invention is to provide a relatively simple and accurate method of coating a light emanating component for an automobile lighting device that can produce standard luminous intensity values.

Another object of the present invention is to provide a device for use in the method of the present invention.

In one aspect, the method of the present invention includes the steps of (a) providing a plurality of light emanating component samples having the first and second zones, (b) providing the light emanating component samples with respective coatings by using a plurality of different coating processes, (c) measuring luminous intensity values of the light emanating component samples produced at the first and second zones before and/or after the light emanating component samples are coated, (d) preparing a first reference plot obtained by plotting the luminous intensity values produced at the first zone of the light emanating component samples versus the coating processes, the first reference plot including a first luminous intensity value which is measured at the first zone of one of the light emanating component samples that has not been coated, (e) preparing a second reference plot obtained by plotting the luminous intensity values produced at the second zone of the light emanating component samples versus the coating processes, the second reference plot including a second luminous intensity value which is measured at the second zone of one of the light emanating component samples which has not been coated, (f) providing a bare light emanating component to be coated, the bare light emanating component having the first and second zones, (g) detecting a third luminous intensity value produced at the first zone of the bare light emanating component, (h) measuring a fourth luminous intensity value produced at the second zone of the bare light emanating component, (i) preparing a first assumption plot which includes the third luminous intensity value but having a profile conforming to that of the first reference plot, and investigating which part of the first assumption plot meets a standard range of luminous intensity values, (j) preparing a second assumption plot which includes the fourth luminous intensity value but having a profile conforming to that of the second reference plot, and investigating which part of the second assumption plot meets a standard range of luminous intensity values, (k) selecting one of the coating processes which renders both of the first and second assumption plots to fall simultaneously within the standard range of luminous intensity values, and (1) coating the bare light emanating component by using the selected one of the coating processes.

In another aspect, a device for performing the method of this invention comprises at least one diagram which includes first and second coordinate axes. The first coordinate axis includes luminous intensity values. The second coordinate axis is divided into a non-coated region, and a plurality of coating process regions each of which includes thickness values of coatings. The diagram further includes a standard luminous intensity area, which covers the standard range of luminous intensity values, and at least one of the first and second reference plots, which is prepared by plotting the values on the first coordinate axis versus the values on the second coordinate axis.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic partly sectional view of an automobile lighting device;

FIG. 2 is a fragmentary schematic sectional view of a light emanating component for the automobile lighting device of FIG. 1 produced by the preferred embodiment of a coating method according to this invention;

FIG. 3 is a diagram including five reference plots for the preferred embodiment;

FIG. 4 is a table including data corresponding to the reference plots of FIG. 3;

FIGS. 5 to 9 are transparent sheets plotted with the reference plots in FIG. 3, respectively;

FIG. 10 is a blank diagram similar to FIG. 3;

FIGS. 11A and 11B are schematic perspective views illustrating how a proper coating process for coating the light emanating component is investigated and selected;

FIG. 12 is a laminar diagram corresponding to FIG. 11B;

FIG. 13 is a diagram including five reference plots for another preferred embodiment of the method according to this invention; and

FIG. 14 is a table including data corresponding to the reference plots of FIG. 13.

### DETAILED DESCRIPTION OF THE PREFERRED EMBODIMENTS

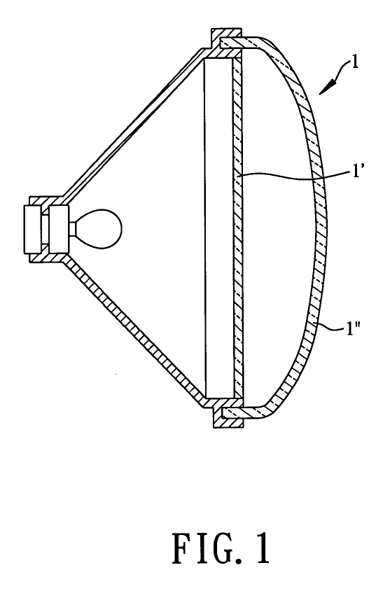

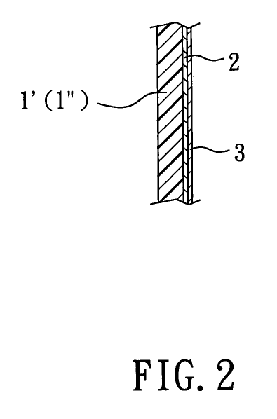

Referring to FIG. 1, an automobile lighting device 1 is illustrated to include two light emanating components, i.e., an inner lens 1′ and an outer lens 1″. Referring to FIG. 2, a coated light emanating component 1′ (1″) for the automobile lighting device of FIG. 1 produced by the preferred embodiment of a method according to this invention is shown. The light emanating component 1′ (1″) has a first coating layer 2 coated thereon, and a second coating layer 3 coated on the first coating layer 2. The light emanating component 1′ (1″) can be a red inner lens, a yellow inner lens, an outer lens, and the like. A plurality of coating processes are available in the art for coating the light emanating component 1′ (1″). For example, if a multi-layer coating process is used, the first coating layer 2 may be made of silicon dioxide, and the second coating layer 3 may be made of titanium dioxide. If an anti-reflection coating process is used, the first coating layer 2 may be made of titanium dioxide, and the second coating layer 3 may be made of silicon dioxide. If a chrome-plating process is used, the first coating layer 2 may be made of chromium, and the second coating layer 3 may be made of silicon dioxide.

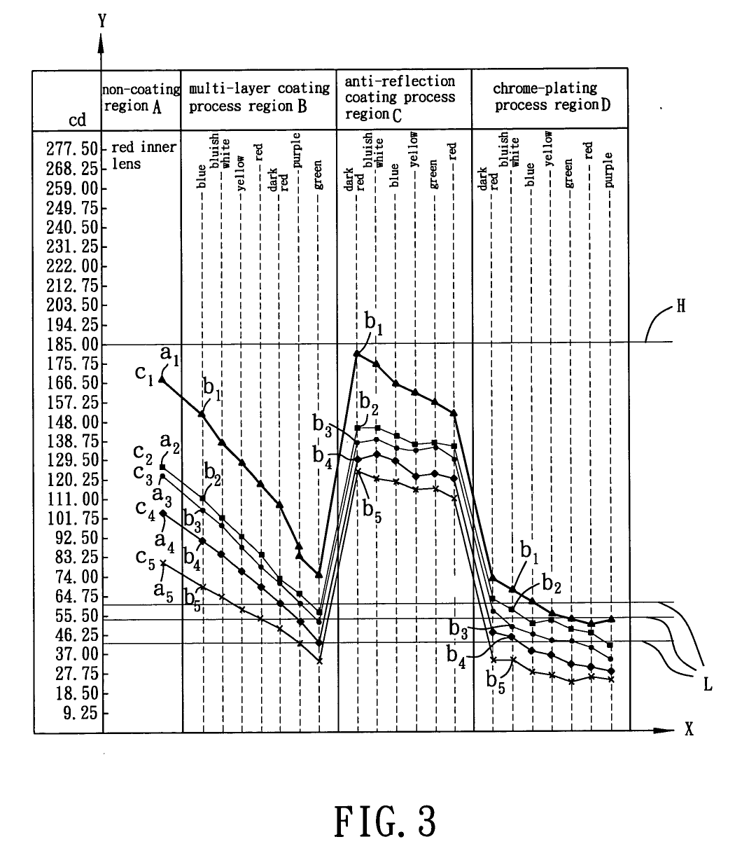

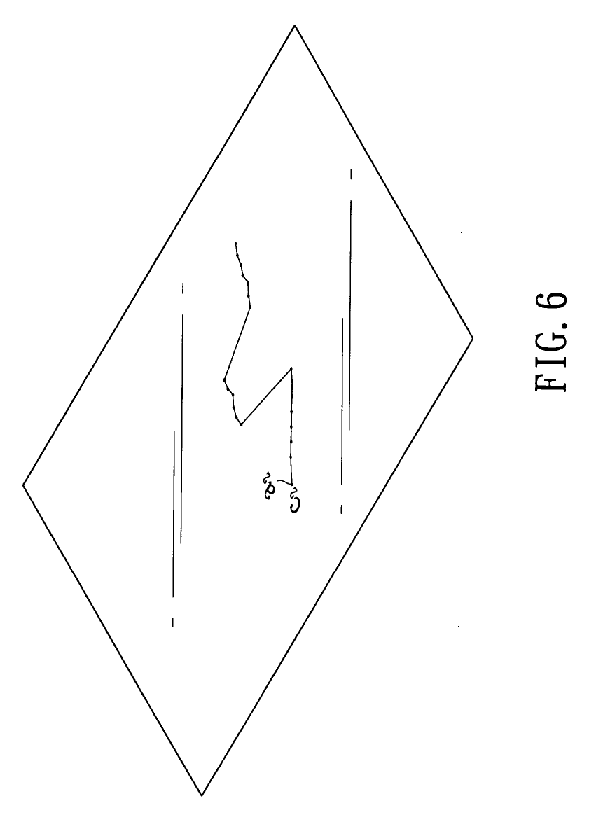

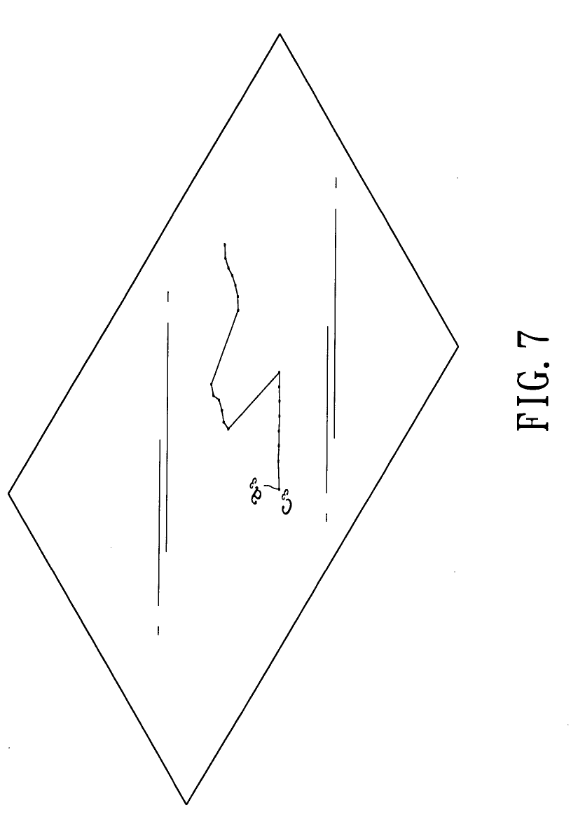

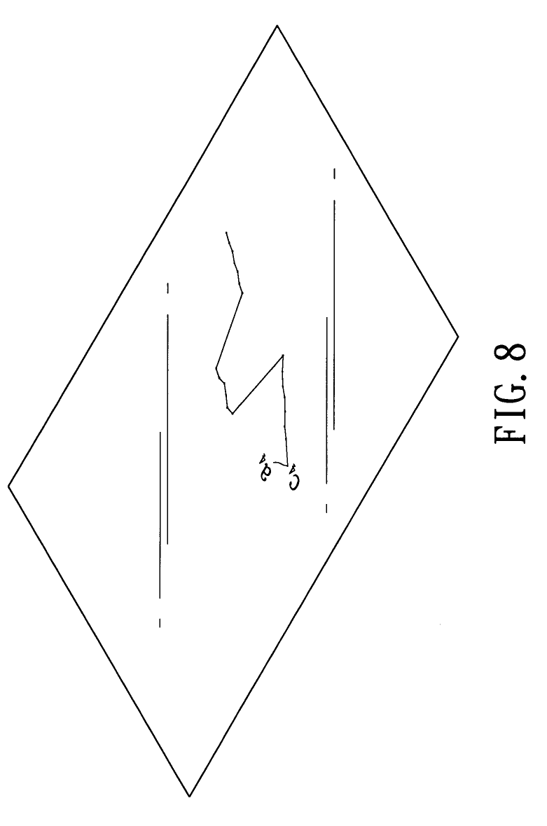

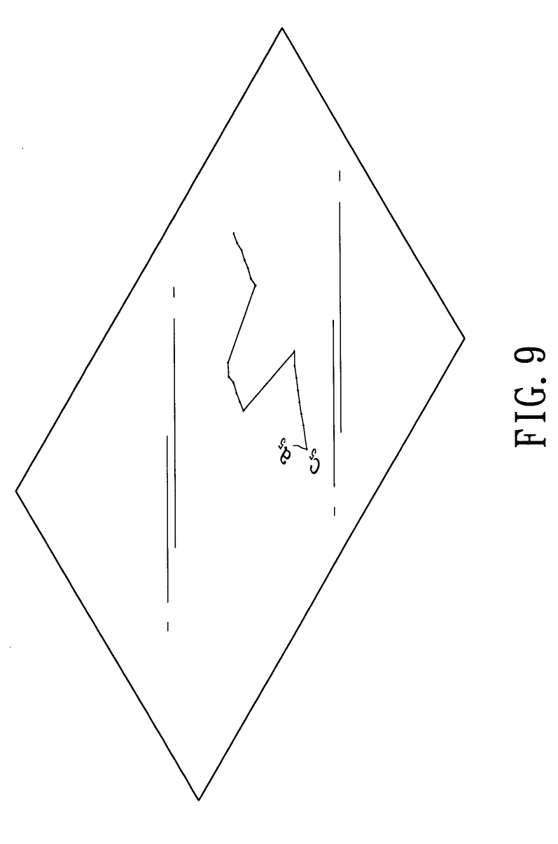

Referring to FIGS. 3 to 12, the preferred embodiment of a method of coating the light emanating component for an automobile lighting device according to this invention is shown to include the steps of:

1) Preparing a Diagram:

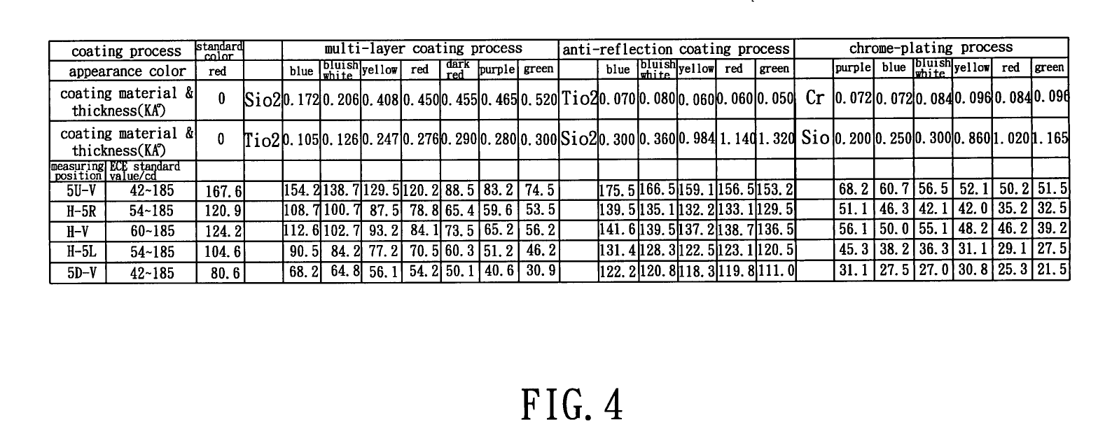

With reference to FIGS. 3 and 4, a blank diagram is plotted first. The diagram includes first and second coordinate axes. The first coordinate axis includes luminous intensity values in a unit of cd (candela). The second coordinate axis is divided into a non-coated region (A), and a plurality of coating process regions including a multi-layer coating process region (B), an anti-reflection coating process region (C), and a chrome-plating process region (D). Each of the coating process regions includes thickness values for different colors. The diagram further includes a standard luminous intensity area which is indicated between line H and line L, and which covers the standard range of luminous intensity values. For example, according to the ECE standard luminous intensities for the taillight, the standard luminous intensity values are 42-185 cd at the first measuring position 5U-V, 54-185 cd at the second measuring position H-5R, 60-185 cd at the third measuring position H-V, 54-185 cd at the fourth measuring position H-5L, and 42-185 cd at the fifth measuring position 5D-V.

2) Providing a Plurality of Light Emanating Component Samples:

In the preferred embodiment, the light emanating component sample is the light emanating component for the taillight of an automobile. Each of the light emanating component samples is defined with the five measuring positions mentioned above.

3) Providing the Light Emanating Component Samples with Respective Coatings:

The light emanating component samples are provided with respective coatings by using a plurality of different coating processes. The coating processes are conducted by forming different kinds of coatings. Each of the coating processes is carried out by varying the thickness of the coating. In the preferred embodiment, the coating processes include:

i) the Multi-Layer Coating Process:

A plurality of the light emanating component samples are prepared for the multi-layer coating process. Each of the light emanating component samples is coated with a first coating layer made of silicon dioxide and a second coating layer made of titanium dioxide. Different coating colors are exhibited on the surface of the coated light emanating component samples by varying the thickness of the coatings. When a coating of silicon dioxide in a thickness of 0.172 k Å and a coating of titanium dioxide in a thickness of 0.105 k Å were coated on the light emanating component sample, a blue coating was formed. When a coating of silicon dioxide in a thickness of 0.206 k Å and a coating of titanium dioxide in a thickness of 0.126 k Å were coated on the light emanating component sample, a bluish white coating was formed. When a coating of silicon dioxide in a thickness of 0.408 k Å and a coating of titanium dioxide in a thickness of 0.247 k Å were coated on the light emanating component sample, a yellow coating was formed. When a coating of silicon dioxide in a thickness of 0.450 k Å and a coating of titanium dioxide in a thickness of 0.276 k Å were coated on the light emanating component sample, a red coating was formed. When a coating of silicon dioxide in a thickness of 0.455 k Å and a coating of titanium dioxide in a thickness of 0.290 k Å were coated on the light emanating component sample, a dark red coating was formed. When a coating of silicon dioxide in a thickness of 0.465 k Å and a coating of titanium dioxide in a thickness of 0.280 k Å were coated on the light emanating component sample, a purple coating was formed. When a coating of silicon dioxide in a thickness of 0.520 k Å and a coating of titanium dioxide in a thickness of 0.300 k Å were coated on the light emanating component sample, a green coating was formed.

ii) the Anti-Reflection Coating Process:

A plurality of the light emanating component samples are prepared for the anti-reflection coating process. Each of the light emanating component samples is coated with a first coating layer made of titanium dioxide and a second coating layer made of silicon dioxide. Different coating colors are exhibited on the surface of the coated light emanating component samples by varying the thickness of the coatings. When a coating of titanium dioxide in a thickness of 0.070 k Å and a coating of silicon dioxide in a thickness of 0.300 k Å were coated on the light emanating component sample, a blue coating was formed. When a coating of titanium dioxide in a thickness of 0.080 k Å and a coating of silicon dioxide in a thickness of 0.360 k Å were coated on the light emanating component sample, a bluish white coating was formed. When a coating of titanium dioxide in a thickness of 0.060 k Å and a coating of silicon dioxide in a thickness of 0.984 k Å were coated on the light emanating component sample, a yellow coating was formed. When a coating of titanium dioxide in a thickness of 0.060 k Å and a coating of silicon dioxide in a thickness of 1.140 k Å were coated on the light emanating component sample, a red coating was formed. When a coating of titanium dioxide in a thickness of 0.050 k Å and a coating of silicon dioxide in a thickness of 1.320 k Å were coated on the light emanating component sample, a green coating was formed.

iii) the Chrome-Plating Process:

A plurality of the light emanating component samples are prepared for the chrome-plating process. Each of the light emanating component samples is coated with a first coating layer made of chromium and a second coating layer made of silicon dioxide. Different coating colors are exhibited on the surface of the coated light emanating component samples by varying the thickness of the coatings. When a coating of chromium in a thickness of 0.072 k Å and a coating of silicon dioxide in a thickness of 0.200 k Å were coated on the light emanating component sample, a purple coating was formed. When a coating of chromium in a thickness of 0.072 k Å and a coating of silicon dioxide in a thickness of 0.250 k Å were coated on the light emanating component sample, a blue coating was formed. When a coating of chromium in a thickness of 0.084 k Å and a coating of silicon dioxide in a thickness of 0.300 k Å were coated on the light emanating component sample, a bluish white coating was formed. When a coating of chromium in a thickness of 0.096 k Å and a coating of silicon dioxide in a thickness of 0.860 k Å were coated on the light emanating component sample, a yellow coating was formed. When a coating of chromium in a thickness of 0.084 k Å and a coating of silicon dioxide in a thickness of 1.020 k Å were coated on the light emanating component sample, a red coating was formed. When a coating of chromium in a thickness of 0.096 k Å and a coating of silicon dioxide in a thickness of 1.165 k Å were coated on the light emanating component sample, a green coating was formed.

4) Measuring Luminous Intensity Values of the Light Emanating Component Samples Produced at the Five Measuring Positions Before and/or After the Light Emanating Component Samples are Coated:

The luminous intensity values of the non-coated light emanating component sample produced at the five measuring positions are measured and indicated in the non-coated region (A) of the diagram by a1, a2, a3, a4, and a5, respectively. The luminous intensity values of each of the coated light emanating component samples produced at the five measuring positions are measured and indicated in the regions (B), (C), and (D) by b1, b2, b3, b4, and b5.

5) Preparing Five Reference Plots for the Five Measuring Positions, Respectively:

Five reference plots (c1, c2, c3, c4, c5) are obtained, respectively, by plotting the luminous intensity values produced at the same measuring position of the light emanating component samples versus the coating processes. Each of the reference plots (c1, c2, c3, c4, c5) includes a luminous intensity value which is measured at each of the measuring positions of the non-coated light emanating component sample, and which is used as a starting point for each of the reference plots (c1, c2, c3, c4, c5).

6) Forming the Five Reference Plots Separately on Five Sheets:

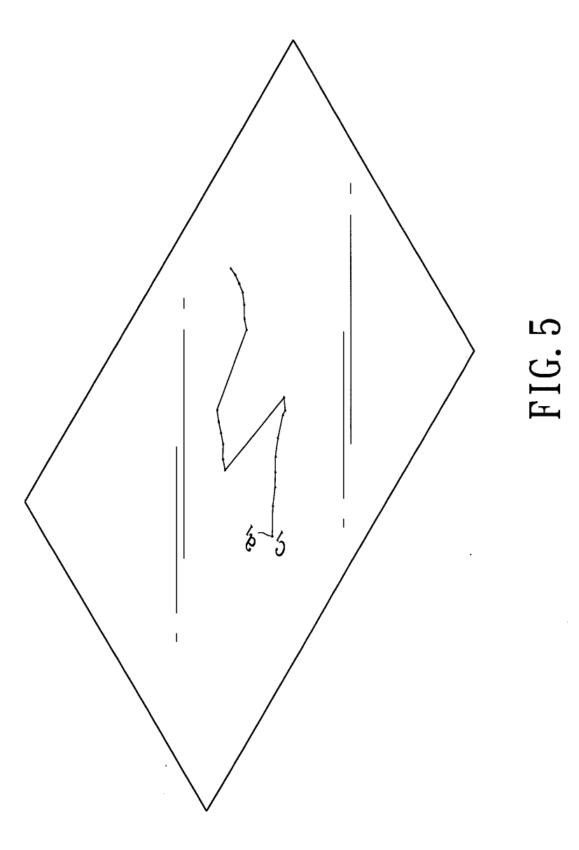

With further reference to FIGS. 5 to 9, the five reference plots (c1, c2, c3, c4, c5) on the diagram of FIG. 3 are reproduced separately on five transparent sheets, such as transparent plastic films.

7) Providing a Bare Light Emanating Component to be Coated:

The bare light emanating component has the five measuring positions defined hereinabove.

8) Detecting the Luminous Intensity Values Produced at the Five Measuring Positions of the Bare Light Emanating Component:

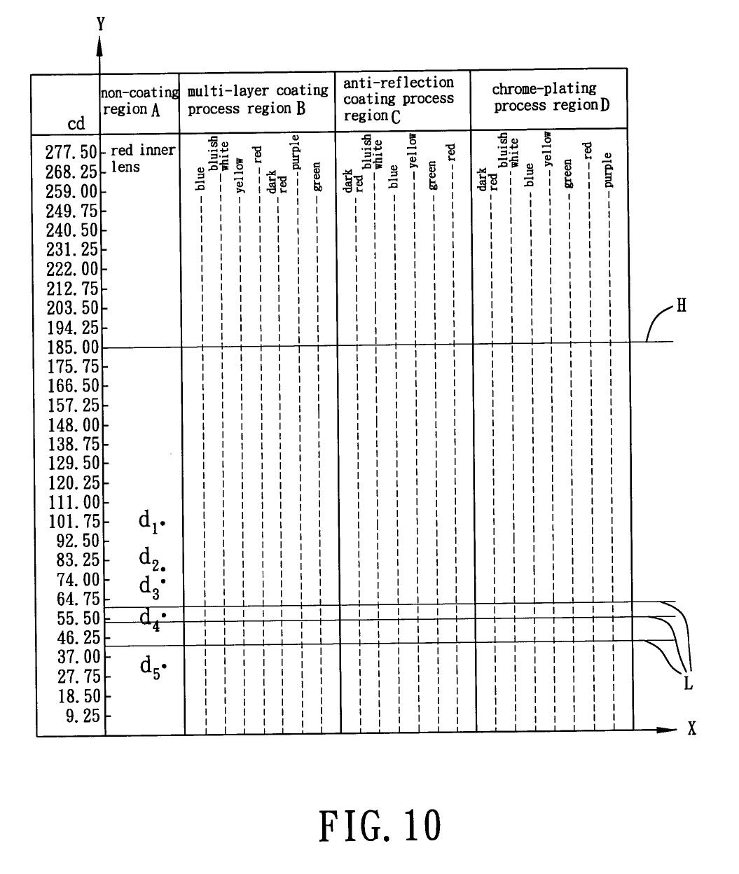

With further reference to FIG. 10, a further single sheet bearing the same diagram as that shown in FIG. 3 is provided. The luminous intensity values produced at the five measuring positions of the bare light emanating component are measured and indicated in the non-coated region (A) of the diagram by d1, d2, d3, d4, and d5, respectively.

9) Preparing Five Assumption Plots:

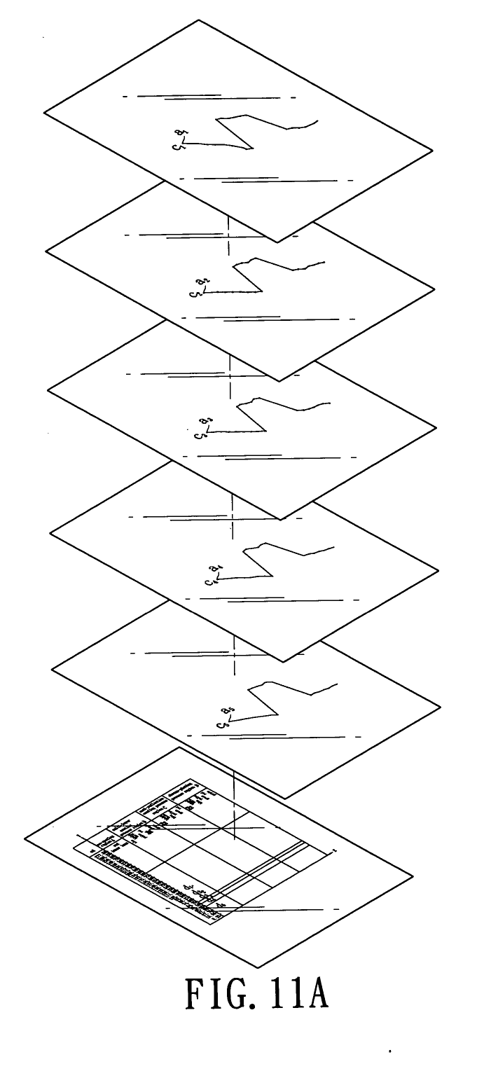

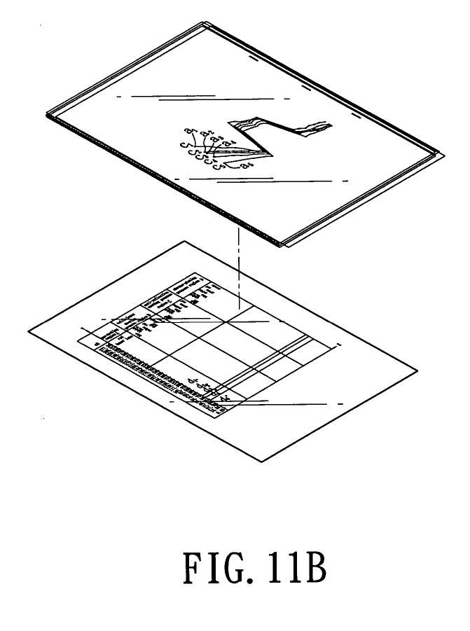

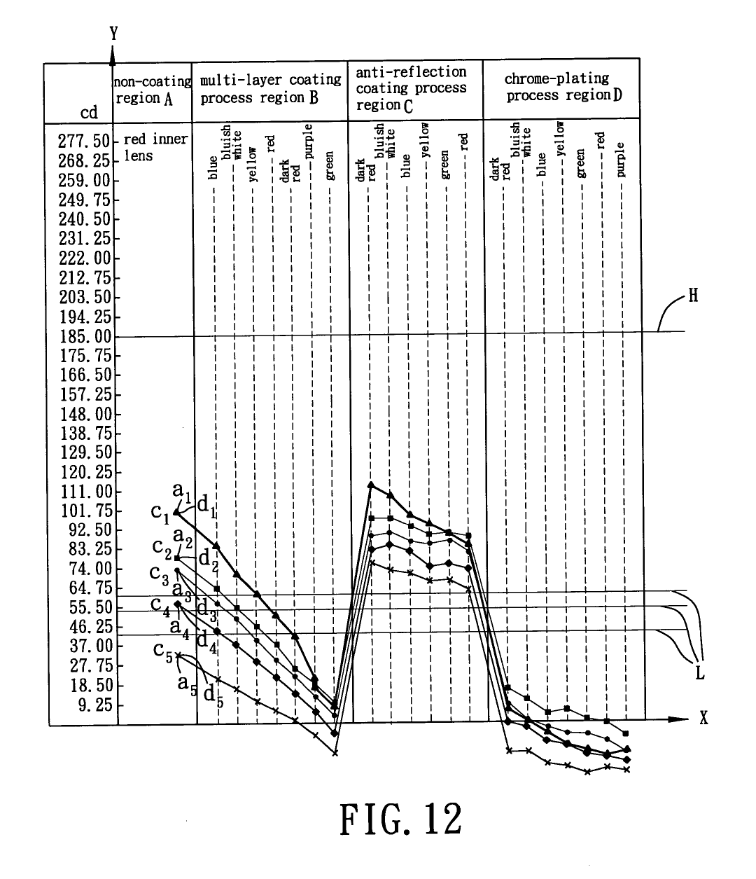

With further reference to FIGS. 11A, 11B and 12, each of the transparent sheets having the reference plots (c1, c2, c3, c4, c5), respectively, are stacked on the further sheet. The starting points (a1, a2, a3, a4, a5) of the reference plots (c1, c2, c3, c4, c5) are registered with the luminous intensity values (d1, d2, d3, d4, d5) of the bare light emanating component correspondingly so as to copy the reference plots on the further sheet. Therefore, five assumption plots are prepared on the further sheet. Each of the assumption plots includes the luminous intensity value measured at one of the measuring positions of the bare light emanating component for use as the starting point of the assumption plot, but has a profile conforming to that of the corresponding one of the reference plots (c1, c2, c3, c4, c5) obtained at the same measuring position. Each of the assumption plots is then investigated to determine which part of each of the assumption plots meets a standard range of luminous intensity values.

10) Selecting a Suitable Coating Process:

A suitable coating process which renders all of the assumption plots to fall simultaneously within the standard range of luminous intensity values is selected as a coating process for the bare light emanating component.

11) Coating the Bare Light Emanating Component:

The bare light emanating component is then coated by using the selected coating process.

In view of the aforesaid, the method according to this invention can predict a suitable coating process for the bare light emanating component to be coated before the coating process is conducted. Therefore, the aforesaid shortcomings of the prior art can be overcome.

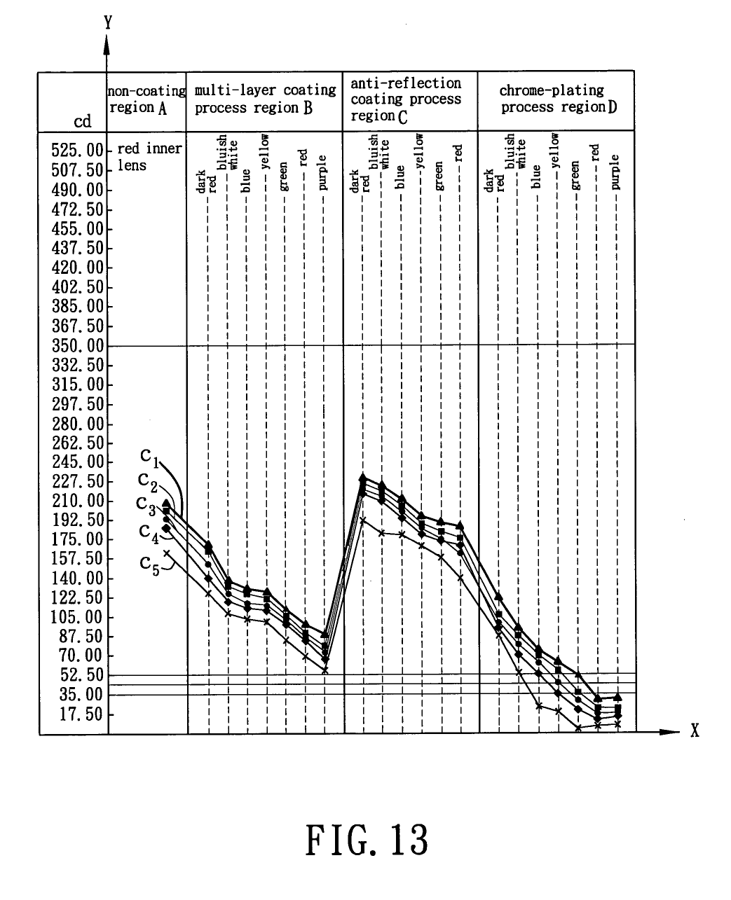

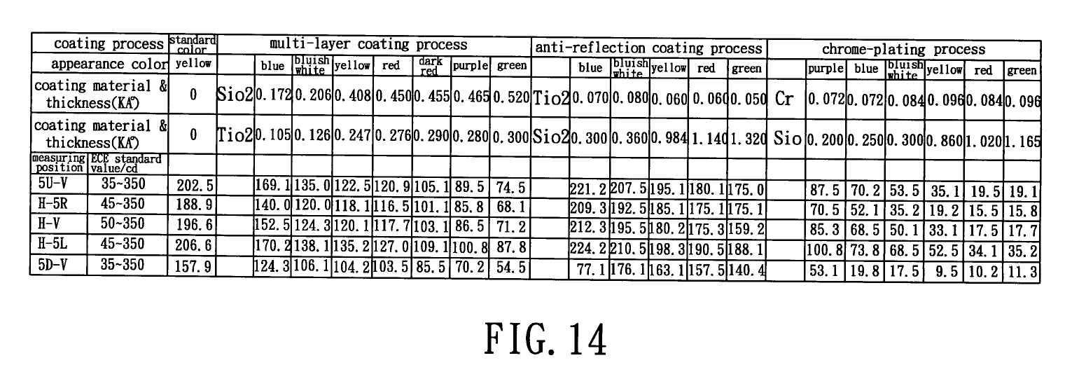

Referring to FIGS. 13 and 14, another preferred embodiment of the method according to this invention is shown to be substantially similar to the aforesaid preferred embodiment, except that the preferred embodiment is used for coating a bare light emanating component which is a yellow inner lens of a taillight for an automobile.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method of coating a light emanating component for an automobile lighting device, in which the light emanating component has at least first and second zones which produce standard luminous intensity values, the method comprising the steps:
(a) providing a plurality of light emanating component samples having the first and second zones;
(b) providing the light emanating component samples with respective coatings by using a plurality of different coating processes;
(c) measuring luminous intensity values of the light emanating component samples produced at the first and second zones before and/or after the light emanating component samples are coated;
(d) preparing a first reference plot obtained by plotting the luminous intensity values produced at the first zone of the light emanating component samples versus the coating processes, the first reference plot including a first luminous intensity value which is measured at the first zone of one of the light emanating component samples that has not been coated;
(e) preparing a second reference plot obtained by plotting the luminous intensity values produced at the second zone of the light emanating component samples versus the coating processes, the second reference plot including a second luminous intensity value which is measured at the second zone of one of the light emanating component samples which has not been coated;
(f) providing a bare light emanating component to be coated, the bare light emanating component having the first and second zones;
(g) detecting a third luminous intensity value produced at the first zone of the bare light emanating component;
(h) measuring a fourth luminous intensity value produced at the second zone of the bare light emanating component;
(i) preparing a first assumption plot which includes the third luminous intensity value but having a profile conforming to that of the first reference plot, and investigating which part of the first assumption plot meets a standard range of luminous intensity values;
(j) preparing a second assumption plot which includes the fourth luminous intensity value but having a profile conforming to that of the second reference plot, and investigating which part of the second assumption plot meets a standard range of luminous intensity values;
(k) selecting one of the coating processes which renders both of the first and second assumption plots to fall simultaneously within the standard range of luminous intensity values; and
(l) coating the bare light emanating component by using the selected one of the coating processes.

2. The method as claimed in claim 1, wherein the coating processes are conducted by forming different kinds of coatings, and each of the coating processes is carried out by varying the thickness of the coating.

3. The method as claimed in claim 2, further comprising preparing a diagram which includes first and second coordinate axes, the first coordinate axis including luminous intensity values, the second coordinate axis being divided into a non-coated region, and a plurality of coating process regions each of which includes thickness values of coatings, the diagram further including a standard luminous intensity area which covers the standard range of luminous intensity values.

4. The method as claimed in claim 3, wherein the first and second reference plots are formed separately on a first sheet and a second sheet.

5. The method as claimed in claim 4, further comprising providing a single third sheet which bears the diagram, wherein both of the first and second assumption plots are prepared on the third sheet, each of the third and fourth luminous intensity values being located in the non-coated region of the diagram on the third sheet, the third and fourth luminous intensity values being used as starting points for the first and second assumption plots, respectively, the first and second luminous intensity values being used as starting points for the first and second reference plots, respectively.

6. The method as claimed in claim 5, wherein the step (i) includes stacking the first sheet and the third sheet, and registering the first luminous intensity value of the first reference plot with the third luminous intensity value to copy the first reference plot on the third sheet.

7. The method as claimed in claim 6, wherein the step (j) includes stacking the second sheet and the third sheet, and registering the second luminous intensity value of the second reference plot with the fourth luminous intensity value to copy the second reference plot on the third sheet.

8. The method as claimed in claim 4, wherein said first and second sheets are transparent plastic films.

9. The method as claimed in claim 1, wherein each of said light emanating component samples and said bare light emanating component is formed as an inner lens of a taillight of an automobile.

10. The method as claimed in claim 1, wherein each of said light emanating component samples and said bare light emanating component is formed as an outer lens of a taillight of an automobile.

11. A device for use in a method of coating a light emanating component for an automobile lighting device, in which the light emanating component has at least first and second zones which produce standard luminous intensity values, and in which the method includes the steps:
(a) providing a plurality of light emanating component samples having the first and second zones;
(b) providing the light emanating component samples with respective coatings by using a plurality of different coating processes;
(c) measuring luminous intensity values of the light emanating component samples produced at the first and second zones before and/or after the light emanating component samples are coated;
(d) preparing a first reference plot obtained by plotting the luminous intensity values produced at the first zone of the light emanating component samples versus the coating processes, the first reference plot including a first luminous intensity value which is measured at the first zone of one of the light emanating component samples that has not been coated;
(e) preparing a second reference plot obtained by plotting the luminous intensity values produced at the second zone of the light emanating component samples versus the coating processes, the second reference plot including a second luminous intensity value which is measured at the second zone of one of the light emanating component samples which has not been coated;
(f) providing a bare light emanating component to be coated, the bare light emanating component having the first and second zones;
(g) detecting a third luminous intensity value produced at the first zone of the bare light emanating component;
(h) measuring a fourth luminous intensity value produced at the second zone of the bare light emanating component;
(i) preparing a first assumption plot which includes the third luminous intensity value but having a profile conforming to that of the first reference plot, and investigating which part of the first assumption plot meets a standard range of luminous intensity values;
(j) preparing a second assumption plot which includes the fourth luminous intensity value but having a profile conforming to that of the second reference plot, and investigating which part of the second assumption plot meets a standard range of luminous intensity values;
(k) selecting one of the coating processes which renders both of the first and second assumption plots to fall simultaneously within the standard range of luminous intensity values; and
(1) coating the bare light emanating component by using the selected one of the coating processes;
wherein the device comprises at least one diagram which includes first and second coordinate axes, the first coordinate axis including luminous intensity values, the second coordinate axis being divided into a non-coated region, and a plurality of coating process regions each of which includes thickness values of coatings, the diagram further including a standard luminous intensity area which covers the standard range of luminous intensity values, and at least one of the first and second reference plots, which is prepared by plotting the values on the first coordinate axis versus the values on the second coordinate axis.
